(19) United States
(12) Patent Application Publication
(10) Pub. No.: US 2014/0143011 A1
(43) Pub. Date: May 22, 2014

(54) SYSTEM AND METHOD FOR APPLICATION-MIGRATION ASSESSMENT

(71) Applicant: DELL PRODUCTS L.P., Round Rock, TX (US)

(72) Inventors: Sridhar Mudugu, Bangalore (IN); Kameswara Rao K.N.V., Hyderbad (IN); Jerish Joseph, Bangalore (IN); Siddharth Jamdar, Mumbai (IN); Sundar Varada Raj Perangur, Bangalore (IN); Julian Turner, Cedar Creek, TX (US)

(73) Assignee: DELL PRODUCTS L.P., Round Rock, TX (US)

(21) Appl. No.: 13/679,508

(22) Filed: Nov. 16, 2012

(51) Int. Cl. G06Q 10/06

(52) U.S. Cl. CPC G06Q 10/0635
USPC 705/7.28

(57) ABSTRACT

In one embodiment, a method includes centrally maintaining a parameter bank comprising a plurality of parameters and a question bank comprising a plurality of questions. The method further includes creating an application-migration assessment. The creating includes receiving a selection of parameters from the parameter bank. The creating also includes providing a list of questions attached to at least one parameter in the selection of parameters. The creating further includes receiving a selection of questions from the list of questions. In addition, the method includes facilitating a taking of the application-migration assessment. Furthermore, the method includes scoring the one or more outcome options based on assessment answers from the taking. Additionally, the method includes generating a recommendation for each of the one or more outcome options based on the scoring.

### BACKGROUND

1. Technical Field

The present invention relates generally to application assessment and more particularly, but not by way of limitation, to systems and methods for assessing outcome options for application migration to a target environment.

2. History of Related Art

As technology advances, an enterprise is often presented with opportunities to improve upon or modernize its legacy data, applications, and services. One such example is that of migration to a cloud environment. Traditionally, the enterprise's data, applications, and services are maintained on-premises behind a firewall. With the recent proliferation of cloud-based solutions, it has become apparent that capital and operational expenditures can be reduced by migrating all or part of the enterprise's data, applications, and services to the cloud.

Cloud computing generally involves the use of computing resources (hardware and software) that are delivered as a service over a network such as the Internet. Accordingly, as used herein, a cloud or a cloud environment refers to a services environment to which the enterprise can entrust with all or part of its data, applications and services. In addition to cost savings, cloud migration potentially provides numerous other advantages such as dynamic scaling, high availability, multi-tenancy, and effective resource allocation. However, cloud migration also presents technical challenges and security concerns.

To alleviate common challenges and concerns, most cloud vendors support a diverse array of cloud models. The existence of options, however, complicates a decision-making process for the enterprise. Further, some data, applications, and services may not be suitable for migration to the cloud. Typically, a consultant with a cloud vendor works with the enterprise to evaluate the cloud models and a feasibility of migrating to the cloud. Significantly, though, the evaluation by the consultant is inherently subjective. Each consultant generally uses their own criteria in a subjective manner. Because there is not generally a way to enforce consistent application of objective criteria, traditional cloud assessments do not generally yield optimal results.

Moreover, as the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment, a method includes centrally maintaining, by a computer system comprising at least one server computer, a parameter bank comprising a plurality of parameters and a question bank comprising a plurality of questions. The method further includes creating, by the computer system, an application-migration assessment designed to evaluate an appropriateness of one or more outcome options for migrating an application to a target environment. The creating includes receiving a selection of parameters from the parameter bank. Each parameter in the selection is a factor determined to have a direct relationship with an appropriateness of at least one of the one or more outcome options. The creating further includes providing a list of questions attached to at least one parameter in the selection of parameters. The creating also includes receiving a selection of questions from the list of questions. In addition, the method includes facilitating, by the computer system, a taking of the application-migration assessment. Moreover, the method includes scoring, by the computer system, the one or more outcome options based on assessment answers from the taking. The method additionally includes generating, by the computer system, a recommendation for each of the one or more outcome options based on the scoring.

In one embodiment, an information handling system includes at least one database operable to centrally store a parameter bank comprising a plurality of parameters and a question bank comprising a plurality of questions. The information handling system also includes at least one server computer communicably coupled to the at least one database. The at least one server computer is operable to centrally maintain the parameter bank and the question bank. The at least one server computer is also operable to create an application-migration assessment that is designed to evaluate an appropriateness of one or more outcome options for migrating an application to a target environment. The creation of the application-migration assessment includes receipt of a selection of parameters from the parameter bank. Each parameter in the selection is a factor determined to have a direct relationship with an appropriateness of at least one of the one or more outcome options. The creation further includes provision of a list of questions attached to at least one parameter in the selection of parameters. In addition, the creation includes receipt of a selection of questions from the list of questions. Furthermore, the at least one server computer is operable to facilitate taking of the application-migration assessment. Additionally, the at least one server computer is operable to score the one or more outcome options based on assessment answers from the taking. The at least one server computer is also operable to generate a recommendation for each of the one or more outcome options based on the scoring.

In one embodiment, a computer-program product includes a computer-usable medium having computer-readable program code embodied therein, the computer-readable program code adapted to be executed to implement a method. The method includes centrally maintaining a parameter bank comprising a plurality of parameters and a question bank comprising a plurality of questions. The method further includes creating an application-migration assessment that is designed to evaluate an appropriateness of one or more outcome options for migrating an application to a target environment. The creating includes receiving a selection of parameters from the parameter bank. Each parameter in the selection is a factor determined to have a direct relationship with an appropriateness of at least one of the one or more outcome options. The creating also includes providing a list of questions attached to at least one parameter in the selection of parameters. The creating further includes receiving a selection of questions from the list of questions. In addition, the method includes facilitating a taking of the application-migration assessment. Furthermore, the method includes scoring the one or more outcome options based on assessment answers from the taking. Additionally, the method includes generating a recommendation for each of the one or more outcome options based on the scoring.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a system for application-migration assessment;

FIG. 2 illustrates a process for creating an assessment type;

FIG. 3 illustrates a process for creating and publishing an assessment to be taken by a customer;

FIG. 4 illustrates a configuration interface for establishing a weight pool;

FIG. 5 illustrates a configuration interface for establishing weight settings and scoring thresholds;

FIG. 6 illustrates a process for providing recommendations based on an assessment taken by a customer; and

FIG. 7 illustrates a configuration interface that can be used to request and receive parameter weights.

### DETAILED DESCRIPTION OF ILLUSTRATIVE EMBODIMENTS OF THE INVENTION

In various embodiments, application migration to a target environment (e.g., a cloud environment) can be facilitated via application-migration assessments as described herein. In a typical embodiment, central repositories of parameters and questions enable a plurality of outcome options to be assessed more effectively and objectively. For purposes of this patent application, an assessment is a set of questions or criteria designed to evaluate an appropriateness of one or more outcome options. An outcome option, as used herein, is a model or solution for implementing the application in the target environment. A parameter, as used herein, is a factor or consideration that has been determined to have a direct relationship with an appropriateness of at least one outcome option.

As described by way of examples below, application-migration assessments can involve actions of a super user, a consultant, and/or a customer. As used herein, a super user is a system user who has been granted privileges to manage master data such as, for example, the central repositories of parameters and questions. A consultant is a system user who creates assessments that are taken by customers. A customer is a system user from an enterprise that is considering application migration to a target environment. Customers generally take assessments that have been created and published by consultants. It should be appreciated that any functionality described below relative to super users, consultants, or customers is exemplary in nature. In various embodiments, such functionality may be distributed differently among any number of system users without deviating from the principles described herein.

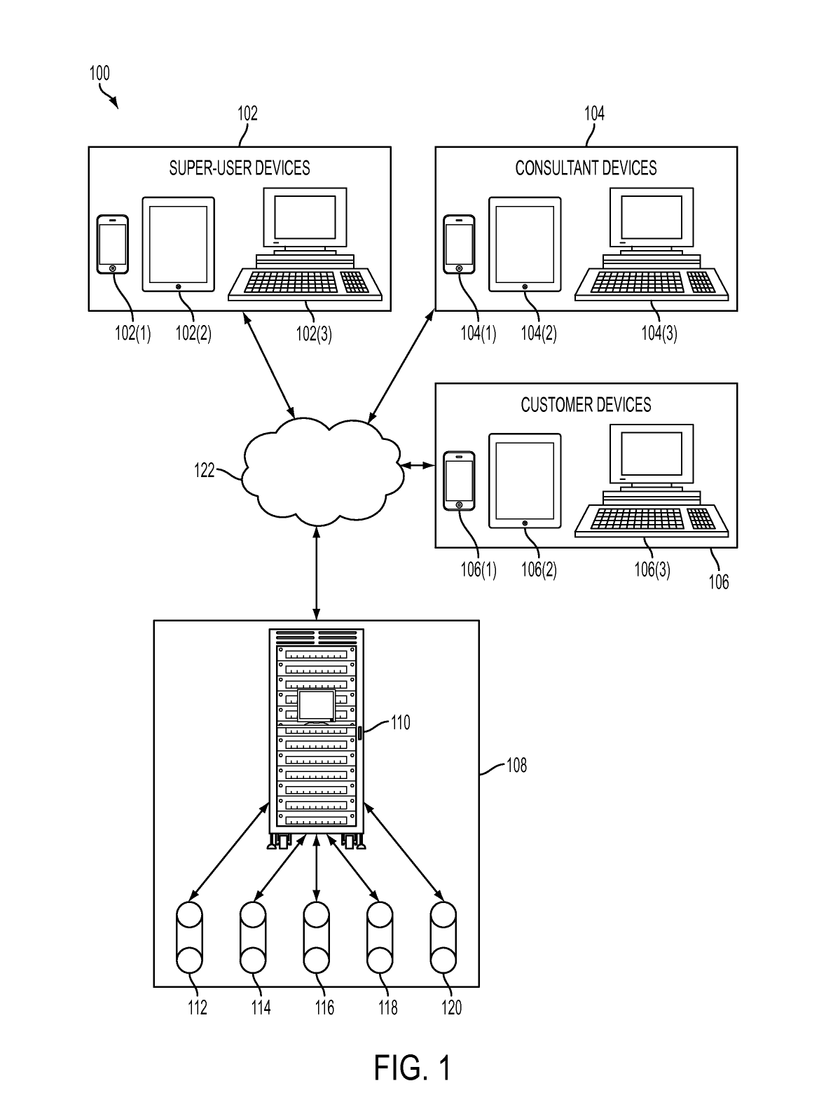

FIG. 1 illustrates a system 100 for application-migration assessment. The system 100 includes a plurality of super-user devices 102, a plurality of consultant devices 104, and a plurality of customer devices 106, all of which communicate with a backend system 108 over a network 122 such as, for example, the Internet. One or more intermediate communications networks such as, for example, a cellular telephone network, may be disposed between a given device and the network 122. The backend system 108 includes at least one server computer 110 that centrally maintains a parameter bank 112, a question bank 114, published assessments 116, assessment settings 118, and assessment templates 120. In various embodiments, the backend system 108 is a virtual machine in a cloud environment.

One of ordinary skill in the art will appreciate that the at least one server computer 110 is exemplary in nature and is shown in order to describe various inventive features to one of ordinary skill in the art. The backend system 108 may utilize any number of physical or virtual computers to perform any functionality described herein with respect to the at least one server computer 110 or the backend system 108. In addition, solely for purposes of example and illustration, the parameter bank 112, the question bank 114, the published assessments 116, the assessment settings 118, and the assessment templates 120 are depicted in FIG. 1 as separate data stores. After reviewing the inventive principles contained herein, one of ordinary skill in the art will appreciate that, in practice, a given implementation need not necessarily store such data separately. For example, in various embodiments, the published assessments 116 and the assessment settings 118 can be stored in a common database.

The plurality of super-user devices 102, the plurality of consultant devices 104, and the plurality of customer devices 106 can each be any type of computing device that is capable of communicating over a network such as, for example, the network 122. By way of example, the plurality of super-user devices 102 is shown to include a smartphone 102(1), a tablet computer 102(2), and a desktop computer 102(3). In similar fashion, the plurality of consultant devices 104 is shown to include a smartphone 104(1), a tablet computer 104(2), and a desktop computer 104(3). Likewise, the plurality of customer devices 106 is shown to include a smartphone 106(1), a tablet computer 106(2), and a desktop computer 106(3). One of ordinary skill in the art will appreciate that other types of devices may also be utilized without deviating from the principles described herein.

The at least one server computer 110 provides an interface over the network 122 for purposes of interacting with members of the system 100. Members are persons or entities that have registered with the system 100 and have been awarded membership. In a typical embodiment, the interface for a given member is unique based on a member type. For example, in a typical embodiment, a user may be classified as a super user, a consultant user, or a customer user and, via the interface, be provided access to appropriate functionality. Depending on whether a given user is a super user, a consultant user, or a customer user, a device operated by the given user may be considered one of the plurality of super-user devices 102, one of the plurality of consultant devices 104, or one of the plurality of customer devices 106, respectively.

In various embodiments, the at least one server computer 110 functions as a web server that serves web pages over the network 122. In these embodiments, the plurality of super-user devices 102, the plurality of consultant devices 104, and the plurality of customer devices 106 each communicate with the at least one server computer 110 via a web browser. In addition, in various embodiments, the at least one server computer 110 is operable to interact with a platform-specific native application loaded onto a computing device. For example, the smartphone 102(1), the smartphone 104(1), and the smartphone 106(1) can each have a native application loaded thereon that performs processing on the device in question and communicates with the at least one server computer 110. By way of further example, the tablet computer 102(2), the tablet computer 103(2), and the tablet computer 104(2) may operate in a similar fashion. Other potential implementations based on the teachings herein will be apparent to one of ordinary skill in the art.

The parameter bank 112 includes a collection of parameters for each assessment type accommodated by the system 100. In a typical embodiment, an assessment type is defined for each category of application-migration assessments supported by the system 100. Assessment types can include, for example, assessments that evaluate outcome options for application migration to a cloud environment and assessments that evaluate outcome options for modernizing a legacy application.

The question bank 114 is a collection of questions that, in a typical embodiment, are each attached to a parameter in the parameter bank 112. Attachment of a question to a parameter means that the question has been determined to help indicate, for at least one outcome option, an extent to which the parameter supports an appropriateness of that outcome option. In a typical embodiment, there is no practical limit on a number of questions that can be attached to a given parameter in the parameter bank 112. In the examples contained herein, each question is attached to a single parameter. However, it should be appreciated that there may be instances in which a given question has a bearing on more than one parameter and is thus attached to more than one parameter.

In a typical embodiment, each question in the question bank 114 is defined by an inquiry and at least two candidate answers. The inquiry is designed to request information directly pertinent to the parameter to which the question is attached. The candidate answers generally cover a domain of possible answers to the inquiry and help indicate, for at least one outcome option, an extent to which the attached parameter supports an appropriateness of the outcome option.

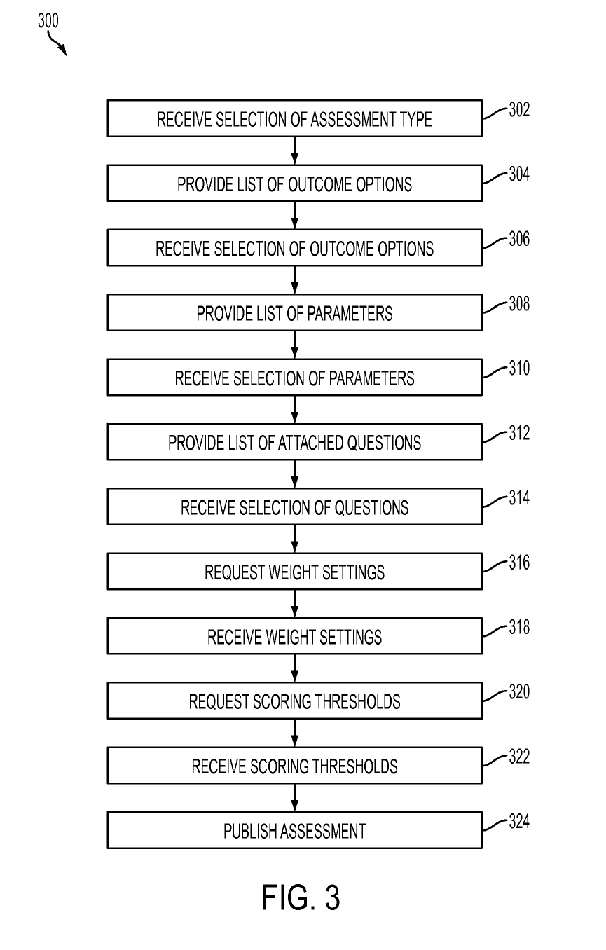

The published assessments 116 are assessments that are ready to be taken, for example, by customers. In a typical embodiment, an assessment becomes a published assessment when a consultant approves the assessment to be taken by at least one customer. An exemplary process for creating and publishing assessments to customers will be described with respect to FIG. 3.

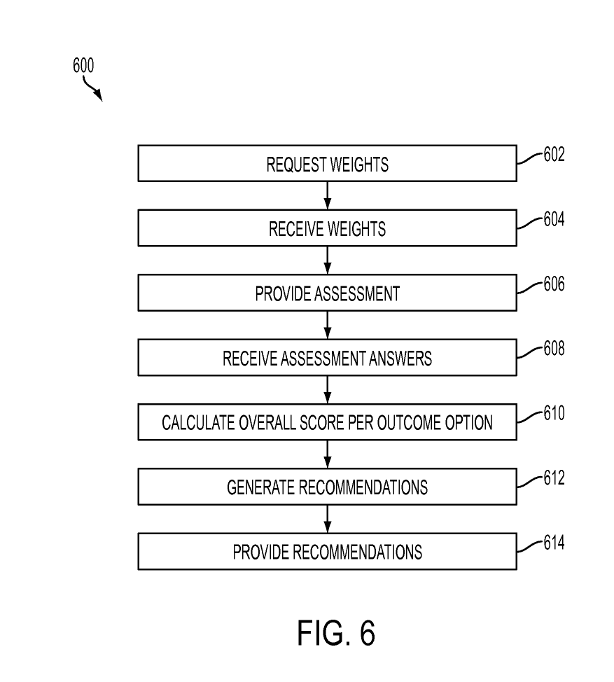

The assessment settings 118 configure, for a given assessment, how an application will be scored relative to one or more outcome options. Examples of how the assessment settings 118 can be established will be described with respect to FIG. 3. Examples of how the assessment settings 118 can be applied to generate scores and recommendations relative to the one or more outcome options will be described with respect to FIG. 6. The assessment templates 120 are generally pre-packaged combinations of assessments and assessment settings that can be used to create a new assessment. The assessment templates 120 can include, for example, previously-used assessments and associated assessment settings.

The plurality of super-user devices 102 interact operationally with the at least one server computer 110 to establish and centrally maintain the parameter bank 112 and the question bank 114 across all customers and consultants. The plurality of consultant devices 104 interact with the at least one server computer 110 to establish the assessment settings 118 and create the published assessments 116. The plurality of customer devices 106 interact with the at least one server computer 110 to take the published assessments 116 and obtain recommendations regarding one or more outcome options.

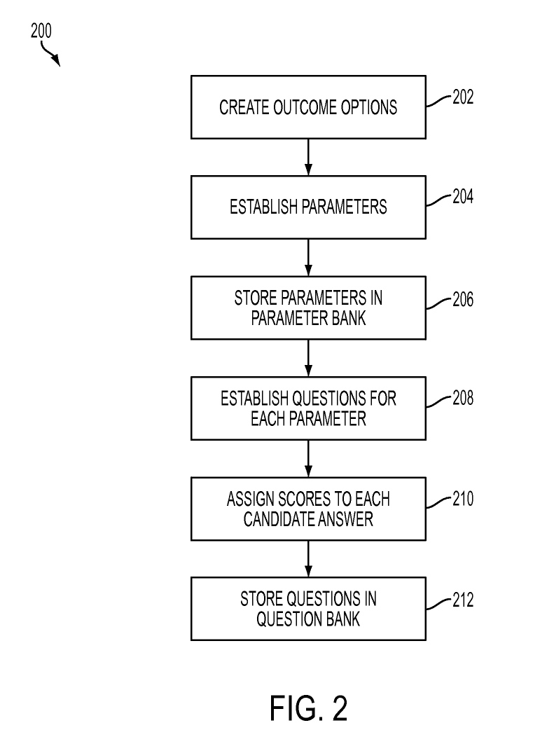

For simplicity of reference, information or data may be described herein as being sent or received by a super user, consultant, or customer without specific reference to a particular user-operated device such as, for example, the plurality of super-user devices 102, the plurality of consultant devices 104, or the plurality of customer devices 106, respectively. Functionality relative to super users, consultants, and customers will be described in more detail below with respect to FIGS. 2-7.

FIG. 2 illustrates a process 200 for creating an assessment type. In a typical embodiment, the process 200 is performed by a system such as, for example, the backend system 108 of FIG. 1, that is in communication with a super user. The process 200 begins at step 202. At step 202, the system creates a plurality of outcome options for the assessment type. In a typical embodiment, the plurality of outcome options is created responsive to being received from the super user. Table 3, which appears in a listing of tables at the end of this Description, is an exemplary list of outcome options for an assessment type of application migration to a cloud environment. From step 202, the process 200 proceeds to step 204.

At step 204, the system establishes parameters for the assessment type. In a typical embodiment, the parameters are established responsive to having been received from the super user. The super user may provide the parameters, for example, via a provided interface. Each parameter typically includes, for example, a name and a description. Table 4, which appears in a listing of tables at the end of this Description, is an exemplary list of parameters that can be established for an assessment type of application migration to a cloud environment. From step 204, the process 200 proceeds to step 206. At step 206, the system stores the parameters in a parameter bank such as, for example, the parameter bank 112 of FIG. 1. From step 206, the process 200 proceeds to step 208.

At step 208, the system establishes questions relative to each parameter. Establishment of the questions typically involves, for each question, receipt of an inquiry and two or more candidate answers from the super user. The questions may be defined, for example, via a provided interface. In a typical embodiment, establishment of a question relative to a parameter constitutes attaching the question to the parameter. Tables 5-16, which appear in a listing of tables at the end of this Description, list exemplary questions for the parameters listed in Table 4. From step 208, the process 200 proceeds to step 210.

At step 210, the system assigns answer scores to each candidate answer defined at step 208. The answer scores may be received, for example, from the super user via an interface served by the system. In a typical embodiment, for each candidate answer, an answer score is defined relative to each outcome option created at step 202. In a typical embodiment, the answer score is a number on a defined numeric scale such as, for example, one to ten. However, it should be appreciated that some answers, by themselves, may render a given outcome option completely untenable. Therefore, in various embodiments, negative scores that are outside the defined numeric scale may be permitted. Table 17, which appears in a listing of tables at the end of this description, provides exemplary answer scores for an exemplary question from Table 11. From step 210, the process 200 proceeds to step 212. At step 212, the system stores the questions in a question bank such as, for example, the question bank 114 of FIG. 1.

FIG. 3 illustrates a process 300 for creating and publishing an assessment to be taken by a customer. In a typical embodiment, the process 300 is performed by a system, such as, for example, the backend system 108 of FIG. 1, that is in communication with a consultant. The process 300 begins at step 302. At step 302, the system receives a selection of an assessment type from the consultant. In a typical embodiment, the assessment type corresponds to a type of migration being considered by the customer. Examples of assessment types include migration to a cloud environment, modernization of a legacy application, enterprise-architecture assessment, and process assessment. From step 302, the process 300 proceeds to step 304.

At step 304, the system provides a list of outcome options from which the consultant can select. Table 3, which appears in a listing of tables at the end of this Description, is an exemplary list of outcome options for an assessment type of application migration to a cloud environment. From step 304, the process 300 proceeds to step 306. At step 306, the system receives a selection of outcome options from the list that was provided at step 304. In a typical embodiment, the selection can include all or a subset of outcome options from the list. From step 306, the process 300 proceeds to step 308.

At step 308, the system provides a list of parameters from which the consultant can select. In a typical embodiment, the list includes parameters that are associated with the selected assessment type in a parameter bank such as, for example, the parameter bank 112 of FIG. 1. Table 4, which appears in a listing of tables at the end of this Description, is an exemplary list of parameters that, in a typical embodiment, can be associated with the selected assessment type. From step 308, the process 300 proceeds to step 310. At step 310, the system receives a selection of parameters from the list that was provided at step 308. In a typical embodiment, the selection can include all or a subset of parameters from the list. From step 310, the process 300 proceeds to step 312.

At step 312, the system provides a list of questions from a question bank such as, for example, the question bank 114 of FIG. 1. The list of questions typically includes those questions in the question bank that are attached to the selected parameters. Tables 5-16, which appear in a listing of tables at the end of this Description, list exemplary questions that may be attached to the parameters listed in Table 4. From step 312, the process 300 proceeds to step 314. At step 314, the system receives a selection of questions from the list that was provided at step 312. From step 314, the process 300 proceeds to step 316.

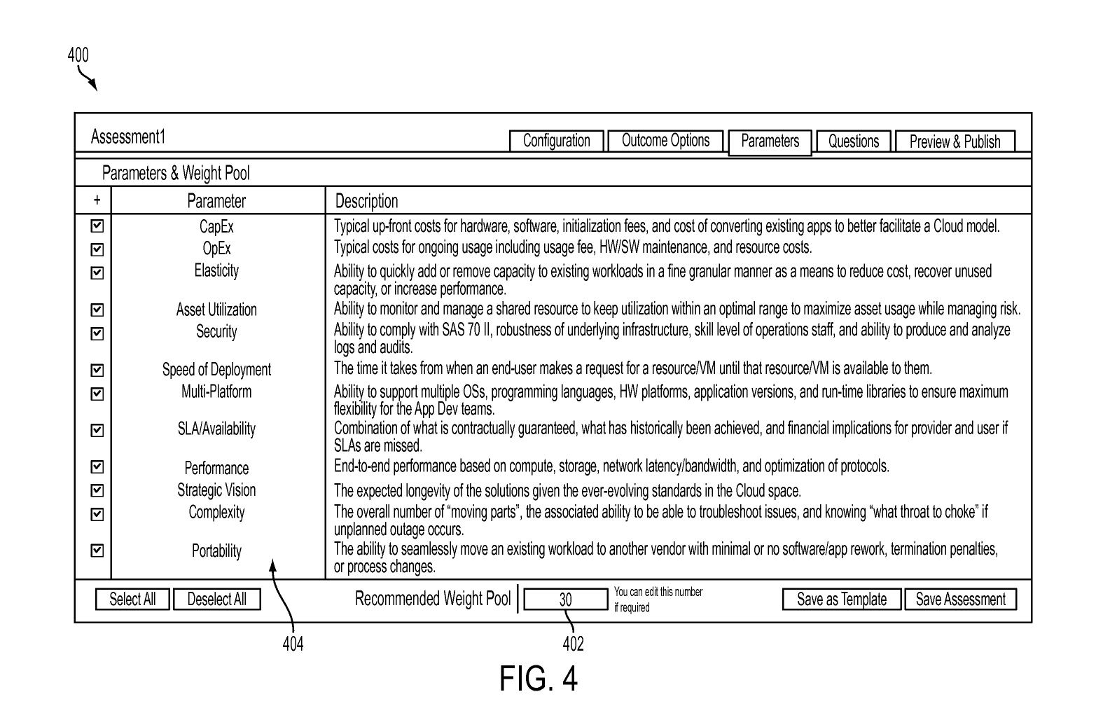

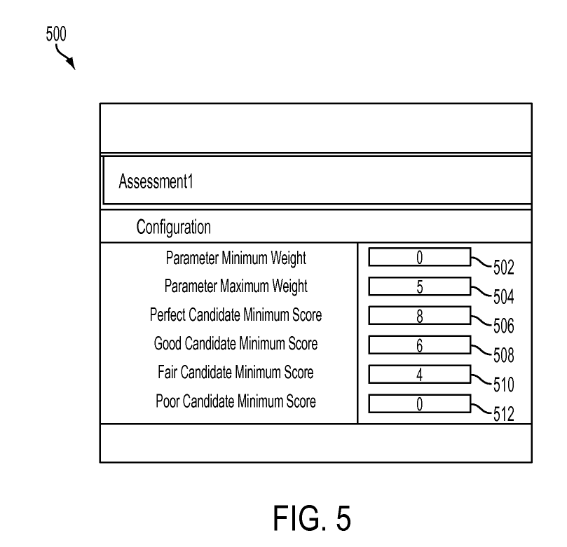

At step 316, the system requests weight settings from the consultant. The weight settings can be requested via, for example, a configuration interface provided to the consultant. In a typical embodiment, the weight settings can include a weight pool that represents an integer number of weights that the customer is permitted to distribute among the selected parameters. In this manner, the customer is enabled to specify that some parameters be given greater consideration than others An example of establishing weight settings will be described with respect to FIGS. 4-5. From step 316, the process 300 proceeds to step 318. At step 318, the system receives the weight settings from the consultant. The weight settings can be stored as part of assessment settings such as, for example, the assessment settings 118 of FIG. 1. From step 318, the process 300 proceeds to step 320.

At step 320, the system requests scoring thresholds from the consultant. A scoring threshold is a minimum score that is required for a given outcome option to achieve a given recommendation. A recommendation is a derived indication of a degree to which a given outcome option is an appropriate choice. As described in more detail below, examples of recommendations are: “poor candidate,” “fair candidate,” “good candidate,” and “perfect candidate.” The scoring thresholds are generally defined relative to a defined numeric scale such as, for example, the defined numeric scale described with respect to FIG. 2. An example of defining scoring thresholds will be described with respect to FIG. 4. From step 320, the process 300 proceeds to step 322. At step 322, the system receives the scoring thresholds from the consultant. The scoring thresholds are typically stored as part of the assessment settings. From step 322, the process 300 proceeds to step 324.

At step 324, the system publishes the assessment. Publication of the assessment typically involves storing the assessment among other published assessments such as, for example, the published assessments 116 of FIG. 1. The published assessment can then be accessed and taken by the customer as described in detail with respect to FIG. 6. In various embodiments, the consultant may also elect to store the assessment and the assessment settings as an assessment template that can be stored, for example, with the assessment templates 120 of FIG. 1. After step 324, the process 300 ends.

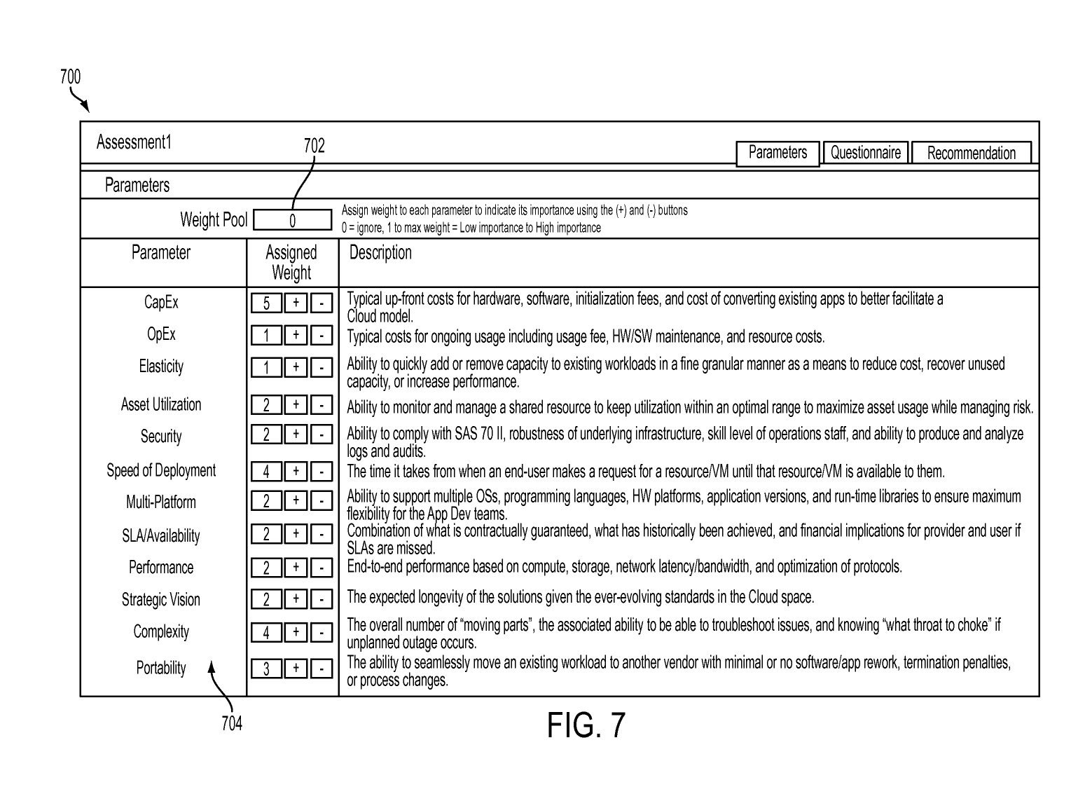

FIG. 4 illustrates a configuration interface 400 for establishing a weight pool as described with respect to step 316 of the process 300 of FIG. 3. The configuration interface lists a plurality of parameters 404 that, as shown, are all selected for consideration in a new assessment. A weight pool 402 represents a number of weights that a customer can distribute among the plurality of parameters 404 when taking the assessment. In a typical embodiment, a value of the weight pool 402 is variable based on a number of parameters in the plurality of parameters 404. For example, as shown, the plurality of parameters 404 includes twelve parameters and the weight pool 402 is thirty. In various embodiments, the weight pool 402 is an editable field that can be configured by a consultant. An example of how the weight pool 402 can be distributed by the customer will be described with respect to FIG. 7.

FIG. 5 illustrates a configuration interface 500 for establishing weight settings and scoring thresholds by a consultant. The configuration interface 500 includes a minimum weight 502, a maximum weight 504, a perfect-candidate minimum score 506, a good-candidate minimum score 508, a fair-candidate minimum score 510, and a poor-candidate minimum score 512. In a typical embodiment, the minimum weight 502 and the maximum weight 504 are weight settings that can be established, for example, as part of steps 316-318 of the process 300 of FIG. 3.

The configuration interface 500 enables the consultant to specify the minimum weight 502 and the maximum weight 502 for purposes of configuring how a customer can distribute a weight pool such as, for example, the weight pool 402 of FIG. 4. As shown in FIG. 5, the minimum weight 502 specifies that the customer is allowed to distribute a zero weight to parameters. In a typical embodiment, if the minimum weight 502 is zero, the customer is permitted to assign a zero weight to a given parameter and thereby have the given parameter effectively ignored for purposes of generating recommendations. In various embodiments, the consultant may select to have the minimum parameter weight be one or greater. As shown in FIG. 5, the maximum weight 504 specifies that the customer cannot give any one parameter a greater weight than five.

The perfect-candidate minimum score 506, the good-candidate minimum score 508, the fair-candidate minimum score 510, and the poor-candidate minimum score 512 represent scoring thresholds as described with respect to steps 320-322 of FIG. 3. Exemplary operation of scoring thresholds will be described in greater detail with respect to FIG. 6.

FIG. 6 illustrates a process 600 for providing recommendations based on an assessment taken by a customer. In a typical embodiment, the assessment is created and published as described with respect to the process 300 of FIG. 3. In a typical embodiment, the process 600 is performed by a system such as, for example, the backend system 108 of FIG. 1, that is in communication with the customer. The process 600 begins at step 602.

At step 602, the system requests parameter weights from the customer for each parameter considered by the assessment. In a typical embodiment, each parameter weight represents all or a portion of a weight pool as described with respect to FIGS. 4-5. From step 602, the process 600 proceeds to step 604. At step 604, the system receives the parameter weights from the customer. From step 604, the process 600 proceeds to step 606. At step 606, the system provides the assessment to the customer. From step 606, the process 600 proceeds to step 608. At step 608, the system receives assessment answers from the customer. The assessment answers generally include a selection of a candidate answer for each question in the provided assessment. As described above, each assessment answer typically has an answer score for each outcome option being considered. From step 608, the process 600 proceeds to step 610.

At step 610, the system calculates an overall score for each outcome option being considered. Each overall score can be calculated by: (1) calculating a product of each answer score and a parameter weight corresponding to the parameter to which the answer score is attached; (2) summing the calculated products; and (3) dividing by a summed total of parameter weights applied at step (1). Table 1 illustrates an example of calculating the overall score for each of outcome options laaS, PaaS, SaaS, private (in-house), and private (hosted). From step 610, the process 600 proceeds to step 612.

TABLE 1

| | ANSWER SCORES BY OUTCOME OPTION | | | | | |
|---|---|---|---|---|---|---|
| Question | | | | Private (In- | Private | Parameter |
| Number | laaS | PaaS | SaaS | house) | (Hosted) | Weight |
| 1 | 9 | 9 | 10 | 10 | 9 | 2 |
| 2 | 10 | 10 | −100 | 10 | 10 | 3 |
| 3 | 4 | 2 | 10 | 10 | 5 | 2 |
| 4 | 5 | −1 | 10 | 10 | 8 | 2 |
| 5 | −100 | −10 | 8 | 10 | 5 | 2 |
| 6 | −10 | −10 | 10 | 10 | 8 | 1 |
| 7 | 10 | −100 | 10 | 10 | 10 | 2 |
| 8 | 1 | −100 | 10 | 9 | 5 | 2 |
| 9 | 10 | 10 | 7 | 10 | 10 | 5 |
| 10 | 10 | 10 | 4 | 10 | 7 | 5 |
| 11 | −1 | −1 | 10 | 1 | 5 | 1 |
| 12 | 3 | 3 | 3 | 10 | 8 | 2 |
| 13 | 7 | 7 | 6 | 10 | 9 | 2 |
| 14 | 4 | 6 | 7 | 8 | 5 | 2 |
| 15 | 10 | 8 | 5 | 9 | 8 | 2 |
| 16 | 7 | 7 | 7 | 5 | 8 | 5 |
| 17 | 10 | 10 | 4 | 10 | 8 | 1 |
| 18 | 9 | 8 | 3 | 10 | 8 | 3 |
| 19 | −10 | −10 | 10 | 10 | 8 | 5 |
| 20 | 10 | 10 | 10 | 10 | 10 | 2 |
| 21 | 10 | 10 | 10 | 10 | 10 | 1 |
| 22 | 8 | 8 | 8 | 8 | 8 | 4 |
| OVERALL | 1.95 | −2.71 | 1.66 | 9.11 | 7.96 | |
| SCORE | | | | | | |

At step 612, the system generates recommendations based on the overall scores. In a typical embodiment, the system maintains scoring thresholds in stored assessment settings such as, for example, the assessment settings 118 of FIG. 1. In a typical embodiment, the scoring thresholds are defined as described with respect to steps 320-322 of FIG. 3. Table 2 below lists exemplary scoring thresholds for each of a plurality of recommendations that include: “perfect candidate,” “good candidate,” “fair candidate,” and “poor candidate.” For purposes of generating the recommendations, each outcome option is assigned a recommendation having a highest scoring threshold that the outcome option can satisfy. In the example of Table 1, laaS and PaaS would constitute “poor” candidates, private (hosted) would constitute a “good” candidate, private (in-house) would constitute a “perfect” candidate. In the example of Table 1, PaaS fails to qualify as even a “poor” candidate due to its negative overall score. From step 612, the process 600 proceeds to step 614.

TABLE 2
EXEMPLARY SCORING
THRESHOLDS

| | Scoring |
|---|---|
| | Threshold |
| Perfect | 8 |
| Candidate | |
| Good Candidate | 6 |
| Fair Candidate | 4 |
| Poor Candidate | 0 |

At step 614, the system provides the recommendations to the customer. Based on the recommendations, the customer is able to determine whether to migrate the application to the target environment. In the example of Table 1, the system would inform the customer that laaS and PaaS constitute “poor” candidates, private (hosted) constitutes a “good” candidate, and private (in-house) constitutes a “perfect” candidate. The system may also report that PaaS cannot be recommended as a candidate. After step 614, the process 600 ends.

FIG. 7 illustrates a configuration interface 700 that may be utilized by a system such as, for example, the backend system 108 of FIG. 1, to request and receive parameter weights from a customer. The configuration interface 700 includes a listing of a plurality of parameters 704 and a weight pool 702. The weight pool 702 is shown to be zero because a predefined allocation of thirty has already been distributed by the customer among the plurality of parameters 704. If, for example, the customer reduces a weight assigned to a given parameter, the weight pool 702 will incrementally increase. In a typical embodiment, the customer is not required to exhaust the weight pool 702.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

TABLE 3
APPLICATION-MIGRATION OUTCOME OPTIONS
(MIGRATION TO CLOUD)

| Outcome Option | Description |
|---|---|
| laaS | Public Infrastructure as a Service |
| PaaS | Public Platform as a Service |
| SaaS | Public Software as a Service |
| Private In-House | Private In-House cloud |
| Private Hosted | Private cloud Hosted by a cloud vendor |
| Hybrid Cloud | Hybrid Cloud |

TABLE 4
APPLICATION-MIGRATION ASSESSMENT PARAMETERS
(MIGRATION TO CLOUD)

| Parameter | Description |
|---|---|
| Capital | Typical up-front costs for hardware, software, |
| Expenditure | initialization fees, and cost of converting existing |
| | applications to better facilitate a cloud model. |
| Operational | Typical costs for ongoing usage including usage fee, |
| Expenditure | hardware/software maintenance, and resource costs. |
| Elasticity | Ability to quickly add or remove capacity to existing |
| | workloads in a fine granular manner as a means to |
| | reduce cost, recover unused capacity, or increase |
| | performance. |
| Asset | Ability to monitor and manage a shared resource to keep |
| Utilization | utilization within an optimal range to maximize asset |
| | usage while managing risk. |
| Security | Ability to comply with SAS 70 II, robustness of |
| | underlying infrastructure, skill level of operations staff, |
| | and ability to produce and analyze logs and audits. |
| Speed of | The time it takes from when an end-user makes a request |
| Deployment | for a resource or virtual machine until that resource or |
| | virtual machine is available to them. |
| Multi-Platform | Ability to support multiple operating systems, |
| | programming languages, hardware platforms, |
| | application versions, and run-time libraries to ensure |
| | maximum flexibility for application-development teams. |
| SLA/ | Combination of what is contractually guaranteed, what |
| Availability | has historically been achieved, and financial |
| | implications for cloud provider and customer if SLAs |
| | are missed. |
| Performance | End-to-end performance based on compute, storage, |
| | network latency/bandwidth, and optimization of |
| | protocols. |
| Strategic | An expected longevity of the solution given the ever- |
| Vision | evolving standards in the Cloud space. |
| Complexity | An overall number of “moving parts,” an associated |
| | ability to be able to troubleshoot issues, and knowing |
| | who to contact if an unplanned outage occurs. |
| Portability | An ability to seamlessly move an existing workload to |
| | another vendor with minimal or no software/application |
| | rework, termination penalties, or process changes. |

TABLE 5
PARAMETER: CAPITAL EXPENDITURE

| Inquiry | Candidate Answers |
|---|---|
| Application | 1 End-of-life application (looking to rewrite or replace) |
| lifecycle? | 2 Established application (looking to re-host only) |
| | 3 New application |

TABLE 6
PARAMETER: OPERATIONAL EXPENDITURE

| Inquiry | Candidate Answers |
|---|---|
| SaaS alternative available? | 1 Maybe (cost or other potential constraints) |
| | 2 Yes |
| | 3 No |
| Duration of virtual | 1 Days/weeks |
| machine? | 2 Forever |
| | 3 Length of project (months) |

TABLE 7
PARAMETER: ELASTICITY

| Question | Candidate Answers |
|---|---|
| Burst duration? | 1 Days |
| | 2 Hours |
| | 3 Minutes |
| Burst nature? | 1 Fairly static usage (peak is +/−50% from average) |
| | 2 Forever |
| | 3 Length of project (months) |

TABLE 8
PARAMETER: ASSET UTILIZATION

| Inquiry | Candidate Answers |
|---|---|
| Frequency of virtual | 1 Often (multiple per week) |
| machine requests? | 2 Seldom (less than one per month) |
| | 3 Some (a few per month) |
| Resource utilization for | 1 4-8 vCPU and 8-32 GB RAM |
| single instance? | 2 <4 vCPU and 8 GB RAM |
| | 3 >8 vCPU and 32 GB RAM |

TABLE 9
PARAMETER: SECURITY

| Inquiry | Candidate Answers |
|---|---|
| Transportability | 1 Confidential but not government controlled |
| of data? | 2 Non-sensitive data (can live anywhere) |
| | 3 Sensitive human-resource or personally-identifying |
| | information data (must stay within country boundaries |
| Secure Access/ | 1 Public data. No authentication required. |
| Single Sign-on? | 2 Single sign-on required across multiple secure |
| | systems |
| | 3 User authentication required for standalone system |
| System/Data | 1 Crown jewels so everything is locked down tight |
| Security? | 2 Static content that can be easily refreshed if |
| | corrupted or compromised |
| | 3 Typical security measures (AD, SAS 70, etc.) |

TABLE 10
PARAMETER: SPEED OF DEPLOYMENT

| Inquiry | Candidate Answers |
|---|---|
| Required speed of | 1 Long lead time OK |
| deployment of | 2 Need it now (<5 minutes) since the business |
| virtual machine | depends on it |
| requests? | 3 Quicker is preferred but cannot assign value to it |

TABLE 11
PARAMETER: MULTI-PLATFORM

| Inquiry | Candidate Answers |
|---|---|
| Application runtime | 1 Requires kernel and/or OS modifications |
| standards? | 2 Some custom libraries and application |
| | programming interfaces (APIs) |
| | 3 Standard Java/.Net libraries and APIs |
| Development | 1 .NET |
| language? | 2 Java |
| | 3 None |
| Hardware platform | 1 All UNIX or mainframe |
| of application? | 2 Mix of x86 and UNIX/mainframe |
| | 3 X86 |

TABLE 12
PARAMETER: SLA/AVAILABILITY

| Inquiry | Candidate Answers |
|---|---|
| Operational maturity? | 1 ITSM 2-3 with standard proactive processes, |
| | procedures, and tools |
| | 2 ITSM 4 or 5 |
| | 3 No in-house monitoring and management |
| Recovery Point Objective | 1 RPO = 0; RTO = minutes |
| (RPO)/Recovery Time | 2 RPO = 24 hours; RTO = days |
| Objective (RTO) | 3 RPO <1 hour; RTO = hours |

TABLE 13
PARAMETER: PERFORMANCE

| Inquiry | Candidate Answers |
|---|---|
| Access method | 1 Anywhere (consumers, vendors, employees, etc.) |
| of users? | 2 Consumers accessing via Internet |
| | 3 Employees accessing only though internal network |
| Geographic | 1 All on one campus |
| nature of users? | 2 Dispersed but mostly same geographic area |
| | 3 Worldwide |
| Application | 1 Highly optimized environment since performance is |
| system | king |
| performance? | 2 Need storage and compute on same LAN to ensure |
| | “good” performance |
| | 3 Not critical. “Good enough” is good enough. |

TABLE 14
PARAMETER: STRATEGIC VISION

| Inquiry | Candidate Answers |
|---|---|
| Ability to define and | 1 None. End users do what they want. |
| enforce standards? | 2 Responsible for setting standards that end |
| | users must follow. |
| | 3 Set standards but defined exception process exists |
| Ability to deploy | 1 Our data center is outsourced |
| standards/reference | 2 We own the data center but some functions are |
| architecture? | outsourced or provided as a service |
| | 3 We run our own data center so no problem |

TABLE 15
PARAMETER: COMPLEXITY

| Inquiry | Candidate Answers |
|---|---|
| All or nothing | 1 Entire application must be within one model |
| for multi-tiered | 2 Pieces of application can be independently moved |
| application? | into cloud |
| | 3 Servers must remain together but storage can be |
| | separate |
| System | 1 Multiple heterogeneous servers and storage |
| interdependence | (complex) |
| and complexity? | 2 Server with external storage (moderate) |
| | 3 Stand-alone server (simple) |

TABLE 16
PARAMETER: PORTABILITY

| Inquiry | Candidate Answers |
|---|---|
| Software license allows for | 1 No |
| non-premise use? | 2 Yes |

TABLE 17
EXEMPLARY SCORES FOR QUESTION:
APPLCATION RUNTIME STANDARDS?
(Parameter: Multiplatform)

| | Hybrid | | | Private | Private In- | |
|---|---|---|---|---|---|---|
| Candidate Answers | Cloud | laaS | PaaS | Hosted | House | SaaS |
| 1 Requires kernel | 0 | 1 | −100 | 5 | 9 | 10 |
| and/or OS | | | | | | |
| modifications | | | | | | |
| 2 Some custom | 0 | 10 | −1 | 5 | 10 | 1 |
| libraries and | | | | | | |
| application | | | | | | |
| programming | | | | | | |
| interfaces | | | | | | |
| (APIs) | | | | | | |
| 3 Standard | 0 | 10 | 10 | 6 | 10 | 8 |
| Java/.Net | | | | | | |
| libraries | | | | | | |
| and APIs | | | | | | |

What is claimed is:

1. A method comprising:
centrally maintaining, by a computer system comprising at least one server computer, a parameter bank comprising a plurality of parameters and a question bank comprising a plurality of questions;
creating, by the computer system, an application-migration assessment designed to evaluate an appropriateness of one or more outcome options for migrating an application to a target environment;
wherein the creating comprises:
receiving a selection of parameters from the parameter bank;
wherein each parameter in the selection is a factor determined to have a direct relationship with an appropriateness of at least one of the one or more outcome options;
providing a list of questions attached to at least one parameter in the selection of parameters; and
receiving a selection of questions from the list of questions;
facilitating, by the computer system, a taking of the application-migration assessment;
scoring, by the computer system, the one or more outcome options based on assessment answers from the taking; and
generating, by the computer system, a recommendation for each of the one or more outcome options based on the scoring.

2. The method of claim 1, wherein the creating comprises receiving a selection of the one or more outcome options.

3. The method of claim 1, wherein the creating comprises receiving assessment settings.

4. The method of claim 3, wherein the receiving assessment settings comprises receiving weight settings and scoring thresholds.

5. The method of claim 1, wherein the facilitating comprises:
receiving a parameter weight for each parameter in the selection of parameters; and
receiving the assessment answers.

6. The method of claim 5, wherein each of the assessment answers has an answer score associated therewith.

7. The method of claim 6, wherein the scoring comprises, for each outcome option of the one or more outcome options:
calculating, for each assessment answer of the assessment answers, a product of the answer score and a parameter weight corresponding to the parameter to which the assessment answer is attached;
summing each calculated product; and
dividing a result of the summing by a summed total of parameter weights applied during the calculating to yield an overall score.

8. The method of claim 7, wherein the generating comprises, for each outcome option of the one or more outcome options:
comparing the overall score to a scoring threshold for each of a plurality of recommendations; and
assigning a recommendation from the plurality of recommendations having a highest scoring threshold satisfied by the overall score.

9. The method of claim 1, comprising providing the assigned recommendation to a customer.

10. An information handling system comprising:
at least one database operable to centrally store a parameter bank comprising a plurality of parameters and a question bank comprising a plurality of questions;
at least one server computer communicably coupled to the at least one database, wherein the at least one server computer is operable to:
centrally maintain the parameter bank and the question bank;
create an application-migration assessment that is designed to evaluate an appropriateness of one or more outcome options for migrating an application to a target environment;
wherein the creation of the application-migration assessment comprises:
receipt of a selection of parameters from the parameter bank;
wherein each parameter in the selection is a factor determined to have a direct relationship with an appropriateness of at least one of the one or more outcome options;
provision of a list of questions attached to at least one parameter in the selection of parameters; and
receipt of a selection of questions from the list of questions;
facilitate taking of the application-migration assessment;
score the one or more outcome options based on assessment answers from the taking; and
generate a recommendation for each of the one or more outcome options based on the scoring.

11. The information handling system of claim 10, wherein the facilitation comprises:
receipt of a parameter weight for each parameter in the selection of parameters; and
receipt of the assessment answers.

12. The information handling system of claim 11, wherein each of the assessment answers has an answer score associated therewith.

13. The information handling system of claim 12, wherein the scoring comprises, for each outcome option of the one or more outcome options:
calculation, for each assessment answer of the assessment answers, of a product of the answer score and a parameter weight corresponding to the parameter to which the assessment answer is attached;
computation of a sum of each calculated product; and
dividing the sum by a summed total of parameter weights applied during the calculation to yield an overall score.

14. The information handling system of claim 13, wherein the generation comprises, for each outcome option of the one or more outcome options:
comparison of the overall score to a scoring threshold for each of a plurality of recommendations; and
assignment a recommendation from the plurality of recommendations having a highest scoring threshold satisfied by the overall score.

15. A computer-program product comprising a computer-usable medium having computer-readable program code embodied therein, the computer-readable program code adapted to be executed to implement a method comprising:
centrally maintaining a parameter bank comprising a plurality of parameters and a question bank comprising a plurality of questions;
creating an application-migration assessment that is designed to evaluate an appropriateness of one or more outcome options for migrating an application to a target environment;
wherein the creating comprises:
receiving a selection of parameters from the parameter bank;
wherein each parameter in the selection is a factor determined to have a direct relationship with an appropriateness of at least one of the one or more outcome options;
providing a list of questions attached to at least one parameter in the selection of parameters; and
receiving a selection of questions from the list of questions;
facilitating a taking of the application-migration assessment;
scoring the one or more outcome options based on assessment answers from the taking; and
generating a recommendation for each of the one or more outcome options based on the scoring.

16. The computer-program product of claim 15, wherein the creating comprises:
receiving a selection of the one or more outcome options;
receiving assessment settings; and
wherein the assessment settings comprise weight settings and scoring thresholds.

17. The computer-program product of claim 15, wherein the facilitating comprises:
receiving a parameter weight for each parameter in the selection of parameters;
receiving the assessment answers; and
wherein each of the assessment answers has an answer score associated therewith.

18. The computer-program product of claim 17, wherein the scoring comprises, for each outcome option of the one or more outcome options:
calculating, for each assessment answer of the assessment answers, a product of the answer score and a parameter weight corresponding to the parameter to which the assessment answer is attached;
summing each calculated product; and
dividing a result of the summing by a summed total of parameter weights applied during the calculating to yield an overall score.

19. The computer-program product of claim 18, wherein the generating comprises, for each outcome option of the one or more outcome options:
comparing the overall score to a scoring threshold for each of a plurality of recommendations; and
assigning a recommendation from the plurality of recommendations having a highest scoring threshold satisfied by the overall score.

20. The computer-program product of claim 19, comprising, for each outcome option of the one or more outcome options, providing the assigned recommendation to a customer.
